(19) United States
(12) Patent Application Publication
(10) Pub. No.: US 2017/0084097 A1
(43) Pub. Date: Mar. 23, 2017

(54) Key Card Replacement App

(71) Applicant: Markis Janis, Mauston, WI (US)

(72) Inventor: Markis Janis, Mauston, WI (US)

(21) Appl. No.: 14/859,229

(22) Filed: Sep. 18, 2015

(51) Int. Cl. G07C 9/00; H04W 4/02; H04M 15/00; H04L 29/08

(52) U.S. Cl. CPC G07C 9/00015; H04L 67/306; H04W 4/021; H04M 15/68

(57) ABSTRACT

The present invention provides a system and method for gaining access through a secured gateway to a health club, gym, spa, hotel room, or the like. The method includes generating an identification code, such as a bar code or QR code, and displaying the code on the display screen of a handheld computing device. The identity of the service provider could be determined by using GPS to get the location of the premises. A scanner installed near the entrance of the premises scans the identification code and allows access. A hand held computing device could be a smart phone, and the identification code could be generated by entering the membership number, which is then processed by the smart phone application to convert the number into an identification code.

### CROSS REFERENCE TO RELATED APPLICATION

Not Applicable

### FEDERALLY SPONSORED RESEARCH AND DEVELOPMENT

Not Applicable

### MICROFICHE APPENDIX

Not Applicable

### BACKGROUND OF THE INVENTION

(1) Field of Invention

The present invention generally relates to method and system for gaining access through a secured gateway.

(2) Background of Invention

Security access cards or key fobs are generally used to gain access to restricted or secured areas, such as health clubs, hotel rooms, gyms, spas, etc. Typically, a person avails membership from the service provider and gets an access card, which allows the person to gain access to the service provider premises and use their services. The access card needs to be swiped through a scanner, which is generally installed near the entry gate. Although the method is reliable and well practiced, carrying the security access card is sometimes bothersome, and it is also quite common that a person simply forgets the access card or misplaces the same. Forgetting the access card often happens while going to a gym or any other healthcare provider. Thus, a convenient method for accessing a restricted area, in particular a healthcare club, spa, gym, etc. has been a long felt need.

Prior art has disclosed many attempts of using a mobile phone as a key instead of plastic cards or key fobs. The use mobile phones has an advantage over physical cards, i.e. the person typical carries his/her mobile everywhere, and has fewer chances to forget the mobile phone. Prior arts disclosing use of mobile phone as means of keyless entry includes U.S. Pat. No. 8,844,811, issued to “April Elizabeth Rogers,” which discloses a method for opening hotel room locks using a smart phone wherein a QRC code is displayed on the screen of smartphone that is scanned by a scanner on the door. The QRC code could be sent by e-mail, or downloaded through the application.

Another, U.S. published patent appl. No. 20130257590, discloses a method of operating electronic locks using a smartphone, wherein the bar code on lock is scanned by the camera of the mobile phone to recognize the lock. Thereafter, the algorithm processed by the smartphone displays the key or bar code, which is scanned by a camera on the door.

The methods of prior art have limited use and are not commercially popular. Thus, a need is appreciated for a method with commercial advantage, particularly for use in heath care services.

### BRIEF SUMMARY OF THE INVENTION

The present invention, therefore, has as its principal objective to provide a system and method for gaining access through a secured gateway.

Another objective of present invention is that the system is a handheld computing device.

Yet another objective is that the method does not require physical key fobs or access cards.

Another objective is that the invention provides access to health clubs, gyms, spas, hotel rooms, etc.

Yet another objective is that the method allows purchasing or subscribing access through Internet connection.

Certain embodiments of current invention provide a system and method for gaining access through a secured gateway of a health club, gym, spa, hotel room, or the like. The method includes generating an identification code, such as a bar code or QR code, and displaying the code on the display screen of a handheld computing device. A scanner installed nearby the entrance of premises scans the identification code and allows access. A hand held computing device could be a smart phone. The identification code could be generated by entering the membership number, which is then processed by the smart phone application to convert the number into an identification code. In a preferred embodiment, the method allows online purchasing of membership to a particular service.

In another embodiment, the system and method of the present invention allows recognizing a particular place, i.e. a gym, spa etc. by determining the location of the computing device through the GPS technology of the computing device.

In addition to the various objectives and advantages of the present invention, described with some degree of specificity above, it should be obvious that additional objectives and advantages of the present invention will become more readily apparent to those persons who are skilled in the relevant art from the following more detailed description of the invention.

### DETAILED DESCRIPTION OF THE INVENTION

The present invention provides a system and method for gaining access through a secured gateway to a health club, gym, spa, hotel room, etc.

Before explaining at least one embodiment of the invention in detail, it is to be understood that the invention is not limited in its application to the details of construction and the arrangements of the components set forth in the following description. The invention is capable of other embodiments, and of being practiced and carried out in various ways. Also, it is to be understood that the phraseology and terminology employed herein are for the purpose of description, and should not be regarded as limiting.

The present invention is a software application for a handheld computing device, such as a smart phone. The application allows keyless entry to restricted areas, such as a spa, gym, hotel room, or any other healthcare club. Typically, such places require a membership/subscription, and the membership is usually a paid membership that is only valid for certain time period. The service provider restricts access to the premises only to members, and may provide electronic access control devices on the entrances that use an access card or a key fob as the password or keys. The users or members are issued such access cards or key fobs, and the user generally has to swipe or show the card against the scanner of the access control device or enter some code from the key fob using the numeric pad of the access control device. The process has a disadvantage that the user may forgot or loose the card. Moreover, the user may have a membership to more than one place, wherein each place may have issued their own access card or key fob. Thus, the user has to carry and manage multiple access cards or key fobs.

People generally carry their smart phone with them most of the times. Thus it could be convenient for a user if they could gain access through access control devices using their mobile phone. Furthermore, the same mobile phone could be used to manage and access all the members subscribed places. For example, a user who has a membership to a gym and a spa could use their same mobile phone to access both places. Thus, the use of mobile phone could be convenient, and saves the user from forgetting or losing their access cards or key fobs.

The software application of current invention could be downloaded and installed by the user on their mobile phone, or the application may be pre-installed by the mobile phone manufacturer. The application displays an identification code, such as a bar code or a QR code, which could be scanned by a scanner installed on an access control machine. The user could receive a unique number or membership information on availing the membership, which could then be entered into the application. An algorithm on the application then converts the entered membership information into an identification code that is stored in the memory of the mobile phone for subsequent access. The application may also allow a user to enter the membership information by scanning a bar code provided by the service provider. For example, the service provider may issue the membership information in the form of a bar code that is printed on a piece of paper. The bar code could then be scanned by the camera of the smart phone. In another embodiment, the application could allow purchasing membership through Internet connection, wherein the application automatically downloads the membership information from the service provider database.

The application may further provide for entering the membership information of multiple service providers, wherein the user could save an entry by the name of service provider or use any nickname. To enter the premises, a user starts the application, and, after the application starts, the user selects an option to display the bar code. For example, a scan button may be provided in the application, and the user selects the scan button to display the identification code. The application could automatically detect the place by determining the present location of the smart phone using GPS, or any other technology obvious to a skilled person for geographical location positioning. The application, on identifying the place, then displays the identification code. The user then positions the mobile phone in front of the scanner, to allow the scanner to scan the identification code.

In another embodiment, the user may manually select the service provider form a list current subscriptions, or the service provider may provide an identification code on the access control device, whereby the user could scan the identification code using the camera of a mobile phone to identify the place. Thus, the current invention may not require an active Internet connection for the application to work.

Besides the use of the application for purchasing membership and working as a key to gain access a restricted area, the application may track the expiration of memberships and notify the user about the same. Also, the application may allow Internet communication to the service provider's database, and provide for editing the profile of the user in the service provider's database. For example, a user may update their profile picture in a gym database.

Those skilled in the art should appreciate that they can readily use the disclosed conception and specific embodiment as a basis for designing or modifying other structures for carrying out the same purposes of the present invention, and that such other structures do not depart from the spirit and scope of the invention in its broadest form.

1. A method of gaining access to a restricted area of a service provider comprises:
receiving and storing membership information from said service provider into a wireless communication device;
processing of a set of instructions stored in said wireless communication device through the processor of the wireless communication device, which converts said membership information to an identification code;
identification of identifying the service provider by determining the location of the restricted area and storing the location in the memory of wireless communication device;
displaying said identification code on the display screen of the wireless communication device;
scanning of the identification code displayed on display screen of the wireless communication device by a scanner installed on an access control device located nearby the entrance of the restricted area of the service provider; and
at least one of: allowing and denying access to said restricted area by die access control device.

2. The method of claim 1, wherein said restricted area of the service provider is a gym.

3. The method of claim 1, wherein said restricted area of the service provider is a spa.

4. The method of claim 1, wherein said restricted area of the service provider is a healthcare club.

5. The method of claim 1, wherein said restricted area of the service provider is a hotel room.

6. The method of claim 1, wherein said wireless communication device is a smart phone.

7. The method of claim 1, wherein said location of the restricted area is determined by the GPS of the wireless communication device.

8. The method of claim 1, wherein said method allows access to restricted areas of more than one service providers.

9. The method of claim 1, wherein said identification code is a Bar code.

10. The method of claim 1, wherein said identification code is a QR code.

11. The method of claim 1, wherein said membership information is a set of numerals that could be input by typing.

12. The method of claim 1, wherein said method further comprises purchasing membership of the service provider through an Internet connection.

13. The method of claim 1, wherein said method further comprises communicating to the service provider's database and updating a user's profile.
